(19) United States
(12) Patent Application Publication
(10) Pub. No.: US 2021/0328236 A1
(43) Pub. Date: Oct. 21, 2021

(54) ELECTROCHEMICAL SYSTEM

(71) Applicant: Reinz-Dichtungs-GmbH, Neu-UIm (DE)

(72) Inventors: Andre SPEIDEL, Bussmannshausen (DE); Stephan WENZEL, Pfaffenhofen (DE); Joachim SCHERER, Ulm (DE)

(21) Appl. No.: 17/267,455

(22) PCT Filed: Aug. 6, 2019
(86) PCT No.: PCT/EP2019/071129

§ 371 Date: Feb. 9, 2021

(30) Foreign Application Priority Data
Aug. 10, 2018 (DE) 20 2018 104 628.4

(51) Int. Cl. H01M 8/0273; H01M 8/1004; H01M 8/0254

(52) U.S. Cl. CPC H01M 8/0273; H01M 8/0254; H01M 8/1004

(57) ABSTRACT

Electrochemical systems having a first separator plate, a second separator plate, and a membrane electrode unit (MEA) arranged between the separator plates. The MEA has a membrane in order to form an electrochemical cell and an edge portion connected to the membrane and comprising a film material for positioning and/or fastening the membrane between the separator plates. The edge portion has at least one elevation and/or depression for stiffening the edge portion at least in regions.

The present invention primarily relates to an electrochemical system.

Known electrochemical systems typically comprise a plurality of separator plates or bipolar plates that are arranged in a stack so that two respective adjacent separator plates or bipolar plates enclose an electrochemical cell. The separator plates or bipolar plates can comprise two respective assembled single plates or can respectively be formed from two assembled single plates. The separator plates can e.g. serve the electrical contacting of the electrodes of the individual electrochemical cells (e.g. fuel cells) and/or the electrical connection of adjacent cells (serial connection of the cells). The separator plates can also serve the dissipation of heat that arises in the cells between the separator plates. Such waste heat can, for instance, arise in the conversion of chemical energy into electrical energy in a fuel cell or conversely in an electrolyzer.

As a rule, the separator plates each have at least one passage opening. The passage openings of the stacked separator plates then form media channels for the supply of media or for the removal of media, said passage opening being arranged in an aligned or at least sectionally overlapping manner. Known separator plates furthermore have sealing arrangements that are each arranged around the passage opening of the separate plate to seal the passage openings or the media channels formed by the passage openings of the separator plates. The sealing arrangements can e.g. be formed as sealing beads shaped, in particular stamped, into the respective single plate and/or as separate or sprayed on elastomer seals.

The separator plates can additionally have channel structures to supply an active region of the separator plate with one or more media and/or for transporting media away. The active region of two separator plates arranged on opposite sides of the cell from one another can e.g. enclose or bound an electrochemical cell. The media can, for example, be fuels (e.g. hydrogen, methanol, or reformate), reaction gasses (e.g. air or oxygen) or media supplied as a coolant and reaction products and heated coolant as removed media. With fuel cells, the reaction media, i.e. fuel and reaction gases, are typically conducted on the surfaces of the separator plates or bipolar plates remote from one another, while the coolant is typically conducted in a hollow space that is, for example, formed between the two individual plates forming the separator plate.

Known separator plates or bipolar plates additionally have distribution regions that are typically arranged between the passage openings and the active region of the plate and that serve to distribute the medium that is supplied to the respective plate via a passage opening of the plate as uniformly as possible over the active region of the plate. The distribution regions can e.g. have distribution structures in the form of webs and channels for this purpose. Other distribution structures are, however, also conceivable. Comparable structures are used to collect a medium that is drained off from the active region and to conduct it to a passage opening. These regions are typically called collection regions. For reasons of simplicity, the distribution regions and the collection regions are here together called distribution and collection region(s). The channel structures of the active region and the distribution regions are typically—usually while including at least one of the aforesaid passage openings—sealed with respect to the outer space. The corresponding externally peripheral sealing arrangements can e.g. be formed as sealing beads shaped, in particular imprinted, into the respective individual plate and/or also as separate or sprayed on elastomer seals.

A respective membrane electrode assembly (MEA) is typically arranged between adjacent separator plates or bipolar plates of the stack to form the electrochemical cell. The MEA here typically respectively comprises a membrane, e.g. an electrolyte membrane, in particular an ionomer membrane, and a marginal section enclosing and connected the membrane. This marginal section serves e.g. to position and fasten the membrane between the adjacent separator plates or bipolar plates; it in particular represents the contact line or the contact region to the at least one sealing element of the adjacent separator plate or bipolar plate. The marginal section normally comprises one or more layers of a film material, e.g. of a thermoplastic or thermosetting film material, that are, for example, joined together by means of an adhesive. While the actual membrane region of the MEA typically spans the electrochemically active region of the cells, the marginal region typically spans the distribution and collection regions and—while forming some recesses—the regions of the separator plate(s) or bipolar plate(s) in which the passage openings and the sealing elements running around them extend.

It is observed in known electrochemical systems that the marginal section of the MEA frequently has insufficient inherent stiffness, which can in particular result in an evasion of the marginal section in the stack direction and thus in problems in the stacking of the cells and separator plates in the positioning and aligning of the MEA by contact at positioning devices and with a force effect that acts within the plane of the MEA and which additionally often requires very high support structures in the separator plates, for example in a region between the outwardly peripheral sealing arrangement and the electrochemically active region, in individual cases also in the distribution region. With known electrochemical systems, it is additionally observed that the marginal section of the MEA partially penetrates in media conducting structures in the distribution region of the adjacent separator plates or bipolar plates and at times impairs the medium flow in this manner due to moisture and/or high temperatures in operation. All this can lead to a reduction of the efficiency of the system and damage to the MEA.

It is thus an underlying object of the present invention to ensure an improved efficiency of the electrochemical system. It is furthermore an underlying object of the present invention to improve the structure stiffness and shape stability of the marginal section of the MEA, in particular in operation, particularly with respect to a deflection in the stack direction. It is in particular an object of the present disclosure to prevent an impairment of the media flow through the marginal section of the MEA.

This object is satisfied by an electrochemical system according to claim 1. The dependent claims describe specific embodiments.

An electrochemical system (also simply called a system for reasons of simplicity in the following) is thus proposed having a first separator plate or bipolar plate, a second separator plate or bipolar plate, and having a membrane electrode assembly (MEA) arranged between the separator plates or bipolar plates. The term separator plate is primarily used in the following, but should in particular also include bipolar plates. The MEA comprises a membrane for forming an electrochemical cell, e.g. in the form of an electrolyte membrane, and a marginal section connected to the membrane and comprising a film material for positioning and/or fastening the membrane between the separator plates. The marginal section has at least one elevated portion and/or recessed portion to stiffen the marginal section.

It is avoided by a corresponding stiffening of the marginal section of the MEA that the marginal section is deflected excessively or even with a small force effect in the stack direction. The penetration of the marginal section into the media conducting structures of the adjacent separator plates, in particular their distribution and collection region(s), can be effectively prevented by a corresponding stiffening of the marginal section of the MEA.

The system typically comprises an electrochemically active region arranged between the first separator plate and the second separator plate. In addition, at least one of the separator plates can have a passage opening and at least one distributor channel arranged or formed in the aforesaid distribution or collection region, preferably, however, a family of distribution channels, that establishes fluid communication between the passage opening and the electrochemically active region. The at least one elevated portion and/or the at least one recessed portion of the marginal section of the MEA can be arranged and formed such that it/they covers/cover the at least one distribution channel at least sectional and/or such that it/they is/are adjacent to the at least one distributor channel.

The system can have a first sealing arrangement to seal the electrochemically active region. The at least one elevated portion and/or at least one recessed portion of the marginal section of the MEA can then be arranged between the first sealing arrangement and the electrochemically active region. Support structures are typically shaped in the separator plate in this region, but can also bring along negative effects on the sealing effect. The at least one elevated portion of the marginal section of the MEA makes it possible here to manage with substantially smaller support structures and nevertheless to fully or at least partially fill or close an intermediate space formed between the first sealing arrangement and the electrochemically active region so that it prevents or reduces an unwanted fluid flow through the intermediate space and past the electrochemical active region despite the lower support structures.

The first separator plate and/or the second separator plate can have at least one passage opening. In addition to the previously described first sealing arrangement for sealing the electrochemically active region, the system can then furthermore have a second sealing arrangement for sealing the at least one passage opening. The at least one elevated portion and/or the at least one recessed portion of the marginal section of the MEA can then be arranged in a region between the first sealing arrangement and the second sealing arrangement in which a spacing of the first sealing arrangement from the second sealing arrangement amounts to at most ten times, preferably at most six times, a minimal spacing between the first sealing arrangement and the second sealing arrangement.

For example, the at least one elevated portion and/or the at least one recessed portion of the marginal section of the MEA can be arranged at a side of the second sealing arrangement between the first sealing arrangement and the second sealing arrangement remote from the electrochemically active region.

The at least one elevated portion of the marginal section of the MEA can at least comprise a first elevated portion elevated toward the first separator plate. And alternatively or additionally, the at least one elevated portion of the marginal section of the MEA can at least comprise a second elevated portion elevated toward the second separator plate.

The marginal section of the MEA can e.g. be formed at least regionally in the manner of a corrugated metal sheet. The elevated portions and/or the recessed portions are then typically provided by wave valleys and wave peaks of the corrugated metal sheet-like region. Such a corrugated metal sheet-like portion can be implemented both in a single layer marginal region and in a multilayer marginal region, optionally also in the presence of adhesive between the layers.

The at least one elevated portion and/or the at least one recessed portion of the marginal section of the MEA can have an elongate shape. Alternatively, the at least one elevated portion and/ at least one recessed portion of the marginal section of the MEA can also be formed in the manner of nubs. It is, however, understood that the at least one elevated portion and/or the at least one recessed portion can also adopt other shapes and is by no means restricted to elongate and/or nub-like shapes. The elevated portions and/or recessed portions can e.g. each have a round, oval, scythe-like, or polygonal cross-section in parallel with plate planes of the separator plates and/or in parallel with a plane defined by the membrane of the MEA.

The at least one elevated portion and/or the at least one recessed portion of the marginal section of the MEA preferably has a direction of its maximum extent, also called a main direction of extent in the following, in a plane in parallel with the plate plane of the MEA that is, for example, spanned along the inner or outer margin of the marginal region. The marginal section of the MEA is here preferably disposed at least sectionally opposite a distribution or collection region of a separator plate having at least one distributor channel. It is preferred here that the at least one distributor channel has a direction of extent that includes an angle of at least 20°, preferably at least 45°, with the main direction of extent of the elevated portion or recessed portion of the marginal section of the MEA. A collapse of the marginal MEA section into the distributor channel or into the plurality of distributor channels is hereby made more difficult or even completely prevented. This is particularly advantageous since neither the GDL nor the actual membrane are disposed opposite the distribution or collection region of the separator plate, but only the marginal region of the MEA.

The at least one elevated portion and/or recessed portion of the marginal section of the MEA can be formed in one part with the marginal section of the MEA. This can e.g. simplify the manufacture and installation of the system and make it less expensive.

The at least one elevated portion and the at least one recessed portion of the marginal section of the MEA can be shaped into the marginal section of the MEA; stamping and/or deep drawing processes are in particular suitable for this. A subsequent shaping by means of heat and/or pressure or even in a cutting process or in another removing process are also generally conceivable. It is generally also possible to manufacture the marginal region directly, for example by means of an injection molding process while forming the elevated and/or recessed portions.

At least one reinforcement element can be arranged at least regionally on the marginal section of the MEA to form the at least one elevated portion of the marginal section of the MEA. This reinforcement element can then, for example, be joined together with the marginal section of the MEA. The at least one reinforcement element and the marginal section of the MEA can comprise the same film material or can be formed from the same film material, with both film material of the same thickness and film material of different thicknesses being able to be combined. A reinforcement element can also be arranged on the marginal section of the MEA in that it is printed on the marginal section, for example by means of 3D printing.

The at least one elevated portion and/or the at least one recessed portion of the marginal section of the MEA can be implemented by a variation of a thickness of the film material of the marginal section of the MEA, for example by means of thermostamping, that is stamping under the effect of heat.

The marginal section of the MEA can at least regionally comprise two film layers connected to one another. The marginal section of the MEA for forming the region of the marginal section of the MEA comprising at least two film layers can e.g. comprise a film section or a film material having a section folded over to double this film section or this film material. The original, non-folded film material can also be of multiple layers here. A fold edge of the folded film section can then, for example, be arranged at an end of the region of the marginal section of the MEA comprising at least two film layers facing the electrochemically active region. The film material of the marginal section of the MEA is preferably gas-tight, of low shrinkage, chemically inert, electrically non-conductive, and temperature resistant, in particular at least in a temperature range from −50° C. to +150° C.

If the marginal section of the MEA has at least two film layers, a first film layer of these at least two film layers facing the first separator plate can have at least one first elevated portion elevated toward the first separator plate. And, alternatively or additionally, a second film layer of these at least two film layers facing the second separator plate can have at least one second elevated portion elevated toward the second separator plate. The separator plates typically each define a plate plane. The plate planes of the first and second separator plates are then typically aligned in parallel with one another. In the region of the marginal section of the MEA comprising at least two film layers, the at least one first elevated portion and the at least one second elevated portion can then be arranged such that a perpendicular projection of the at least one first elevated portion and a perpendicular projection of the at least one second elevated portion at least partially overlap one another and/or are arranged at least partially offset from one another in or one a plane aligned in parallel with the plate planes of the separator plates.

The region of the marginal section of the MEA comprising at least two film layers can comprise an adhesive layer arranged between the film layers. The at least one elevated portion and/or the at least one recessed portion of the marginal section of the MEA can then be implemented, for example, by a variation of a thickness of the adhesive layer. Alternatively or additionally, the at least one elevated portion and/or the at least one recessed portion can also be implemented by insert elements arranged at least regionally between the film layers in the region of the marginal section of the MEA comprising at least two film layers.

If the at least one elevated portion and/or the at least one recessed portion of the marginal section of the MEA is/are not achieved by material removal (adhesively bonded or folded film material, printing, adhesive), but rather by shaping the film material, the at least one elevated portion and/or the at least one recessed portion is/are stable in shape under normal installation conditions and in normal operation. With mechanical pressure effects going slightly beyond the usual operating conditions, the elasticity of the marginal section of the MEA can serve to avoid a plastic deformation of the regions of the distribution and collection regions of the separator plate adjacent to this marginal section. If, however, an extreme application of pressure occurs, the at least one elevated portion and/or the at least one recessed portion is/are plastically pressed, at times permanently completely, without any unwanted plastic deformation of the adjacent distributor channels in the separator plate occurring.

Embodiments of the electrochemical system proposed here are shown in the Figures and will be explained in more detail by means of the following description. In this respect, reference numerals that are the same or similar always designate the same or similar elements so that their mention is not repeated in part. It is essential that the present electrochemical system in accordance with the invention can be further developed in a variety of manners. The following examples each show a combination of further developing, advantageous features for an electrochemical system in accordance with the invention. It is, however, also possible to further develop the electrochemical system only by individual features and properties of a single exemplary electrochemical system in accordance with the invention or also by means of a combination of features and properties from different ones of the following examples. There are shown:

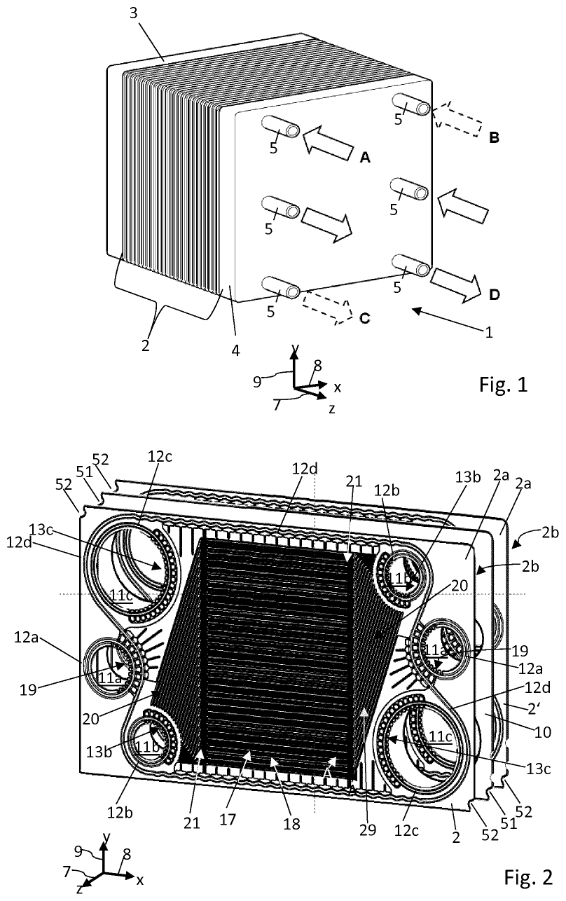

FIG. 1 schematically in a perspective illustration an electrochemical system with a plurality of separator plates or bipolar plates arranged in a stack;

FIG. 2 schematically in a perspective illustration two separator plates of a system similar to FIG. 1 with a membrane electrode assembly (MEA) arranged between two separator plates;

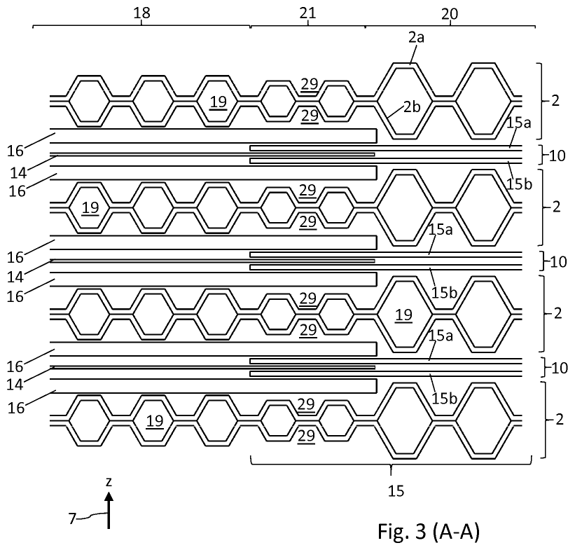

FIG. 3 schematically, a section through a plate stack of a system in the manner of a system in accordance with the section A-A in FIG. 2;

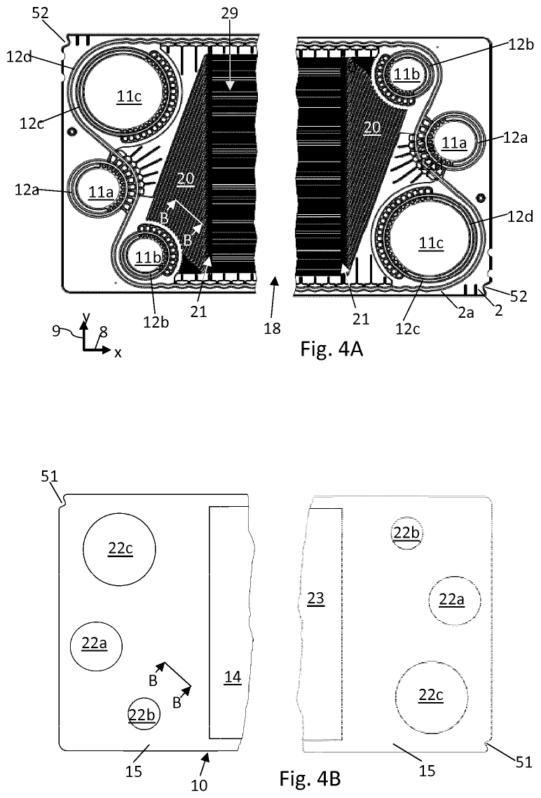

FIG. 4A schematically, a separator plate in accordance with FIG. 2 in a plan view;

FIG. 4B schematically, the MEA in accordance with FIG. 2 in a plan view.

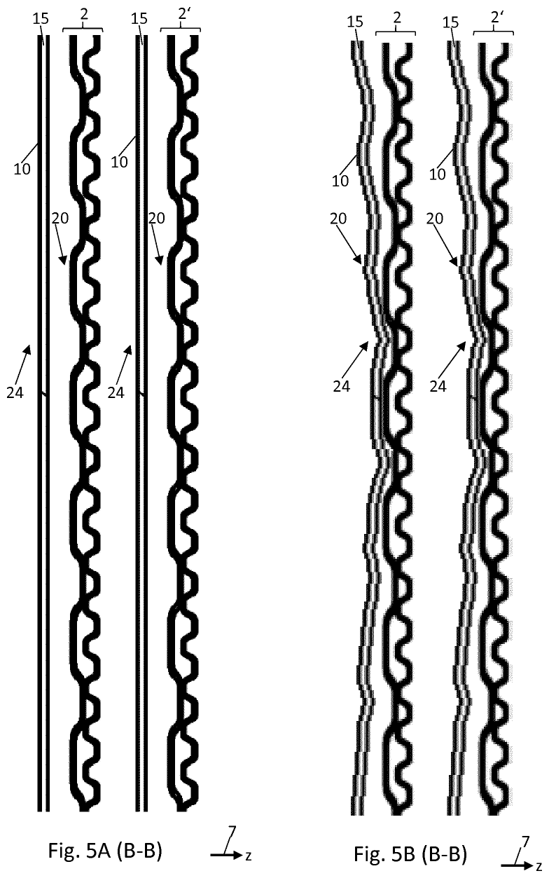

FIG. 5A schematically, separator plates and MEAs ideally arranged between the separator plates in accordance with the prior art in a sectional illustration;

FIG. 5B schematically, the separator plates and MEAs in accordance with FIG. 5A in operation, with the MEAs partially penetrating into media conducting structures of the adjacent separator plates;

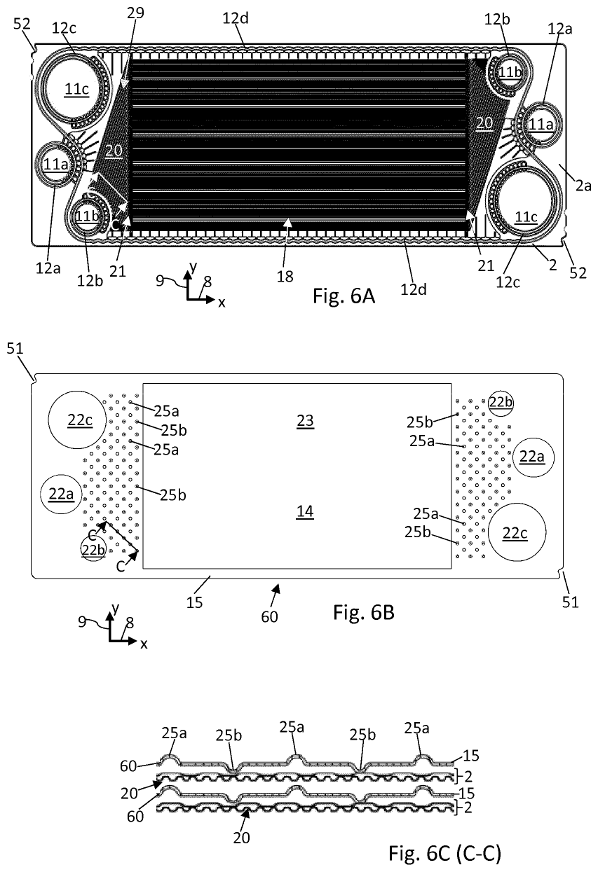

FIG. 6A schematically, the separator plate in accordance with FIG. 2 in a plan view;

FIG. 6B schematically, an MEA of the kind proposed here in a plan view;

FIG. 6C schematically, separator plates in accordance with FIG. 6A and MEAs arranged between the separator plates in accordance with FIG. 6B in a sectional illustration;

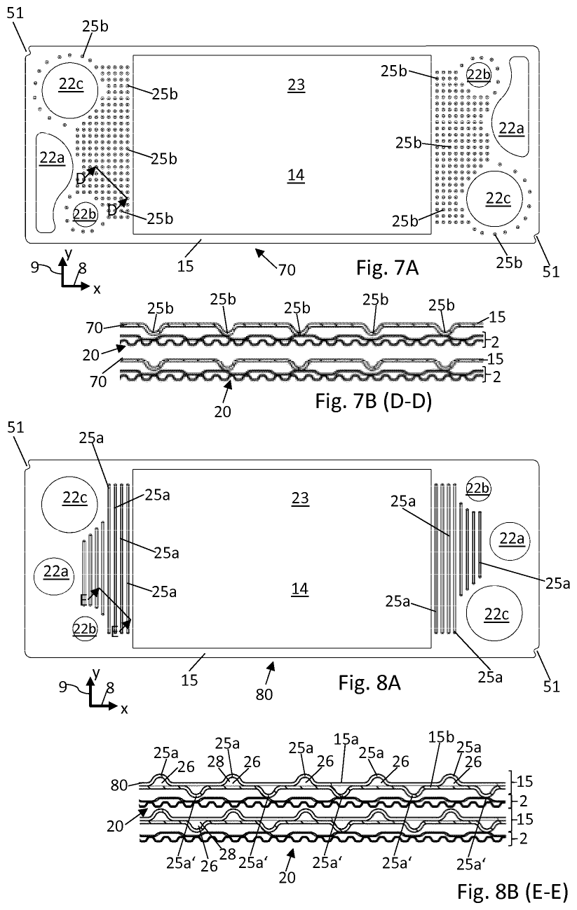

FIG. 7A schematically, an MEA of the kind proposed here in accordance with a further embodiment, in a plan view;

FIG. 7B schematically, separator plates and MEAs arranged between the separator plates in accordance with FIG. 7A in a sectional illustration;

FIG. 8A schematically, an MEA of the kind proposed here in accordance with a further embodiment in a plan view;

FIG. 8B schematically, separator plates and MEAs arranged between the separator plates in accordance with FIG. 8A in a sectional illustration;

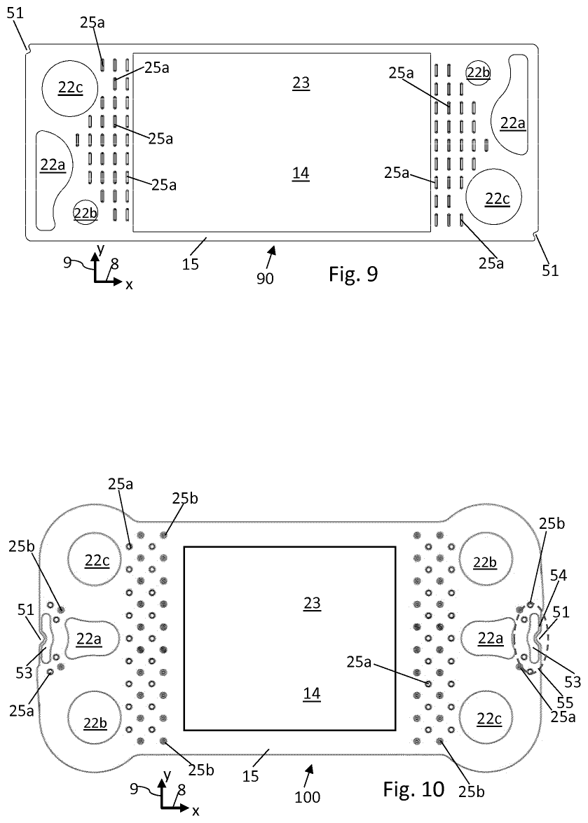

FIGS. 9, 10 schematically, further embodiments of MEAs of the kind proposed here in a plan view;

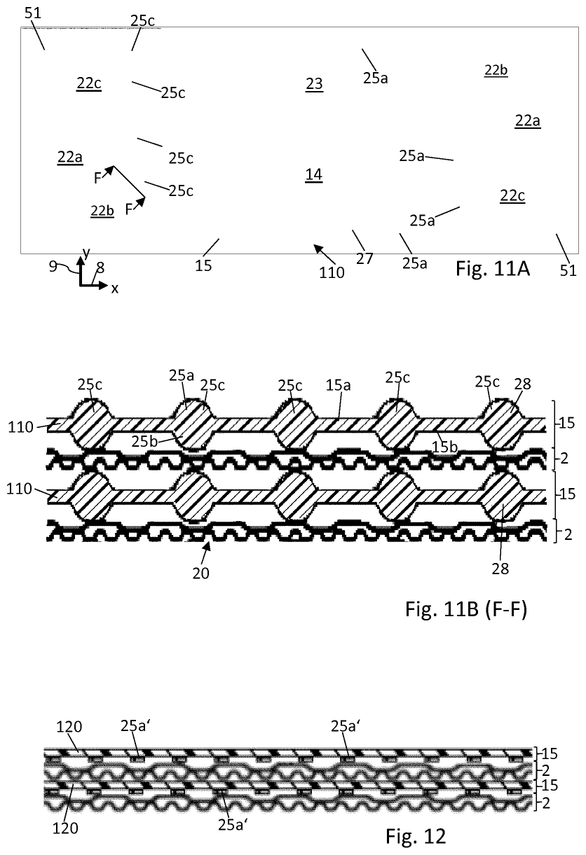

FIG. 11A schematically, an MEA of the kind proposed here in accordance with a further embodiment, in a plan view;

FIG. 11B schematically, separator plates and MEAs arranged between the separator plates in accordance with FIG. 11A in a sectional illustration;

FIG. 12 schematically, separator plates and MEAs of the kind proposed here arranged between the separator plates in accordance with a further embodiment in a sectional illustration;

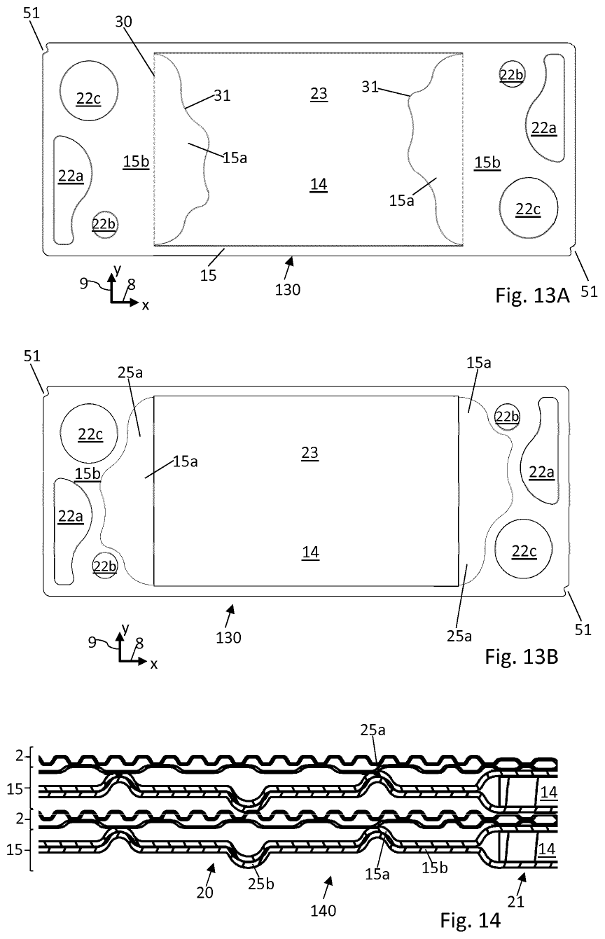

FIG. 13A schematically, an MEA of the kind proposed here in accordance with a further embodiment during manufacture in a plan view;

FIG. 13A schematically, the MEA in accordance with FIG. 13A in a finished shape in a plan view; and

FIG. 14 schematically, separator plates and MEAs arranged between the separator plates in accordance with a further embodiment in a sectional illustration.

FIG. 1 shows an electrochemical system 1 of the kind proposed here having a plurality of metallic separator plates or bipolar plates 2 of the same construction that are arranged in a stack and are stacked along a z direction 7. The separator plates 2 of the stack are clamped between two end plates 3, 4. The z direction 7 is also called the stacking direction. In the present example, the system 1 is a fuel cell stack. Two adjacent separator plates 2 of the stack in each case thus enclose between them an electrochemical cell, which is used, e.g., for converting chemical energy into electrical energy. So as to form the electrochemical cells of the system 1, a respective membrane electrode assembly (MEA) is arranged between adjacent separator plates 2 of the stack (see e.g., FIG. 2). The MEAs typically each contain at least one membrane, e.g., an electrolyte membrane. Furthermore, a gas diffusion layer (GDL) can be arranged on one or both surfaces of the MEA.

In alternative embodiments, the system 1 can equally be configured as an electrolyzer, a compressor, or as a redox flow battery. Separator plates can likewise be used in these electrochemical systems. The design of these separator plates can then correspond to the design of the separator plates 2 explained in more detail here, even though the media conducted on or through the separator plates with an electrolyzer, with an electrolytic cell compressor, or with a redox flow battery can respectively differ from the media used for a fuel cell system.

The z axis 7 together with an x axis 8 and a y axis 9 spans a right hand Cartesian coordinate system. The separator plates 2 in each case define a plate plane, wherein the plate planes of the separator plates are each aligned parallel to the x-y plane, and thus perpendicular to the stacking direction or to the z-axis 7. The end plate 4 includes a plurality of media connections 5, via which media are suppliable to the system 1 and via which media are dischargeable out of the system 1. These media that may be supplied to the system 1 and discharged out of the system 1 may, e.g., include fuels such as molecular hydrogen or methanol, reaction gases such as air or oxygen, reaction products such as water vapor, or depleted fuels or coolants such as water and/or glycol.

FIG. 2 shows a perspective view of two adjacent separator plates or bipolar plates 2 of an electrochemical system of the type of the system 1 from FIG. 1, as well as a membrane electrode assembly (MEA) 10, which is known from the related art, arranged between these adjacent separator plates 2, wherein the MEA 10 in FIG. 2 is largely hidden by the separator plate 2 facing the observer. The separator plate 2 is formed from two integrally joined individual plates 2a, 2b (see e.g., FIG. 3), of which only the first individual plate 2a facing the observer is visible in FIG. 2, which hides the second individual plate 2b.

The individual plates 2a, 2b may be made of sheet metal, such as stainless steel sheet. The individual plates 2a, 2b may, e.g., be welded together, e.g., by laser welded connections.

The individual plates 2a, 2b have mutually aligned through-openings, which form through-openings 11a-c of the separator plate 2. When a plurality of separator plates of the type of separator plate 2 are stacked, the through-openings 11a-c form ducts extending through the stack 2 in the stacking direction 7 (see FIG. 1). Typically, each of the ducts formed by the through-openings 11a-c is in fluid connection with one of the ports 5 in the end plate 4 of the system 1. Coolant can e.g. be introduced into the stack or drained out of the stack via the lines formed by the passage openings 11a. The lines formed by the passage openings 11a, 11b in contrast can be formed for the supply of the electrochemical cells of the fuel cell stack of the system 1 with fuel and with reaction gas and for removing the reaction products from the stack.

To seal the passage openings 11a-c with respect to the interior of the stack 2 and with respect to the environment, the first single plate 2a has respective sealing arrangements in the form of sealing beads 12a-c that are each arranged around the passage openings 11a-c and that each completely surround the passage openings 11a-c. The second single plate 2b has corresponding sealing beads for sealing the passage openings 11a-c (not shown) at the rear side of the separator plates 2 remote from the observer of FIG. 2.

In an electrochemically active region 18, the first single plates 2a have a flow field 17 at their front side facing the observer of FIG. 2, said flow field 17 having structures for conducting a reaction medium along the front side of the single plate 2a. These structures are provided in FIG. 2 by a plurality of webs and channels extending between the webs and bounded by the webs. At the front side of the separator plate 2 facing the observer of FIG. 2, the first single plate 2a additionally has a distribution or collection region 20 having distribution channels 29. The distribution or collection region 20 comprises structures that are adapted to distribute a medium introduced, starting from a first of the two passage openings 11b, into the distribution or collection region 20 via the active region 18 and/or, starting from the active region 18, to distribute or bundle medium flowing toward the second of the passage openings 11b. The distribution structures of the distribution or collection area 20 in FIG. 2 are likewise provided by webs, and channels extending between the webs and delimited by the webs. A respective transition region 21, which in FIG. 2 is aligned parallel to the y direction 9, is located on both sides of the flow field 17 at the transition between the distribution and collection region 20 and the flow field 17 of the active area 18. In the transition region 21, the media guidance structures in each case have a reduced height, e.g., compared to the adjacent areas 18 and 20 (see FIG. 3).

The first individual plates 2a furthermore comprise a further sealing system in the form of a perimeter bead 12d, which extends around the flow field 17 of the active area 18, the distribution or collection area 20 and the through-openings 11b, 11c and seals these with respect to the through-opening 11a, i.e., with respect to the coolant circuit, and with respect to the surroundings of the system 1. The second single plates 2b each comprise corresponding perimeter beads. The structures of the active region 18, the distribution structures of the distribution or collection region 20 and the sealing beads 12a-d are reach formed in one part with the single plates 2a and are shaped into the single plates 2a, e.g. in a stamping or deep drawing process. The same applies to the corresponding structures of the second single plates 2b.

The two passage openings 11b or the lines formed by the passage openings 11b through the plate stack of the system 1 are each in fluid communication with one another via leadthroughs 13b in the sealing beads 12b, via the distribution structures of the distribution or collection region 20, and via the flow field 17 in the active region 18 of the first single plates 2a facing the observer of FIG. 2. Similarly, the two through-openings 11c or the ducts formed by the through-openings 11c through the plate stack of the system 1 are each in fluid connection with one another via corresponding bead passages, via corresponding distribution structures, and via a corresponding flow field on an outer side of the second individual plates 2b facing away from the observer of FIG. 2. In contrast, for example, the through-openings 11a or the ducts formed by the through-openings 11a through the plate stack of the system 1 are each in fluid connection with one another via a cavity 19 that is enclosed or surrounded by the individual plates 2a, 2b. This hollow space 19 respectively serves the guidance of a coolant through the separator plate 2, in particular to cool the electrochemically active region 18 of the separator plate 2.

FIG. 3 schematically shows a section A-A through a section of the plate stack of the system 1 of FIG. 1, with the sectional plane being oriented perpendicular to the plate planes of the separator plates 2. The separator plates 2 of the same construction of the stack each comprise the previously described first single plate 2a and the previously described second metallic single plate 2b. The active region 18, the transition region 21, and the distribution or collection region 20 of the separator plates 2 are further shown, with the regions 18, 21, 20 each having structures along the outer surfaces of the separator plate 2, here in particular respectively in the form of webs and of channels bounded by the webs.

A membrane electrode assembly (MEA) 10 known e.g. from the prior art is respectively arranged between adjacent separator plates 2 of the stack. The MEAs 10 each comprise a membrane 14, e.g. an electrolyte membrane, and a marginal section 15 connected to the membrane 14. The marginal section 15 can, for example, be connected to the membrane 14 with material continuity, e.g. by an adhesive connection or by lamination. The marginal section 15 is formed from a film material, e.g. from a thermoplastic film material or from a thermosetting film material.

The membrane 14 of the MEA 10 respectively extends at least over the active region 18 of the adjacent separator plates 2 and there makes possible an electrochemical reaction at the membrane 14. The membrane 14 furthermore at least partially reaches into the transition region 21. The marginal section 15 of the MEA 10 respectively serves the positioning and fastening of the MEA 10 between the adjacent separator plates 2. The separator plates 2 here have notches or recesses 52; the MEA 10 has notches or recesses 51 as lateral positioning aids. The separator plates 2 and the MEAS 10 are each alternately stacked on one another such that their positioning aids 52, 51 are laterally adjacent to positioning devices, not shown here, and are guided by them. Since the MEA is very easily movable and bendable, there is, however, the risk that the MEA is not positioned correctly since it can, for example, fold or arch, i.e. can in particular evade in the stack direction. The MEA can thus evade the correct location toward the bipolar plate.

If the separator plates 2 of the system 1 are clamped between the end plates 3, 4 in the stack direction (see FIG. 1), the marginal section 15 of the MEA 10 can, for example, respectively be pressed between the sealing beads 12a-d of the respectively adjacent separator plates 2 or respectively between the parameter beads 12d of the adjacent separator plates 2 to fix the membrane 14 between the adjacent separator plates 2 in this manner.

The marginal section 15 respectively at least partially covers the distribution or collection region 20 of the adjacent separator plates 2 or reaches at least partially into the distribution or collection region 20 of the adjacent separator plates 2. As shown in FIG. 3, the marginal section 15 can additionally also fully or at least partially cover the transition region 21 of the adjacent separator plates 2 or can fully or at least partially reach into the transition region 21 of the adjacent separator plates 2. The marginal section 15, however, preferably does not reach up to and into the active region 18 so that it does not impair the media exchange over the membrane 14 in the active region 18 or impairs it as little as possible.

The marginal section 15 of the MEA 10 in FIG. 3 respectively comprises a first film layer 15a and a second film layer 15b, with the film layers 15a, 15b each being connected to the membrane 14. In FIG. 3, the film layers 15a, 15b in the region 21 are arranged at least in part at both sides of the respective membrane 14 and encompass it along the stack direction or along the z direction 7. The film layers 15a, 15b are connected to the membrane 14 or to one another in the region 20 by means of an adhesive that is usually not explicitly named in this document and that is generally also not provided with its own reference numeral. The spaced apart illustration of the film layers 15a, 15b is therefore simplified; in actual fact, the film layers 15a, 15b lie at least sectionally, at least indirectly, above one another, i.e. connected via an adhesive layer. The MEA 10 in the transition region 21 of the marginal section 15 thus respectively has a larger thickness than in the region of the MEA 10 different from or encompassed by the transmission region 21, with the thickness of the MEA 10 respectively being determined along the stack direction or along the z direction 7.

As shown in FIG. 3, gas diffusion layers 16 can additionally be arranged in the active region 18. The gas diffusion layers 16 enable the flowing onto the membrane 14 over a region of the surface of the membrane 14 that is as large as possible and can thus improve the media exchange over the membrane 14. The gas diffusion layers 16 can e.g. be respectively arranged at both sides of the membrane 14 in the active region 18 between the adjacent separator plates 2. The gas diffusion layers 16 can e.g. be formed from a nonwoven fabric or can comprise a nonwoven fabric. To receive both the reinforced marginal section 15 of the MEA 10 and the gas diffusion layers 16 in the transition region 21, the media conducting structures of the transition region 21 preferably have a height that is reduced with respect to the media conducting regions of the adjacent regions 18 and 20 so that an excessive pressing of the separator plates 2, of the MEAS 10, and of the gas diffusion layers 16 is prevented in the transition region 21.

FIG. 4a shows two sections of the separator plate 2 of FIG. 2, in particular of the first single plate 2a of the separator plate 2 of FIG. 2 in a plan view.

FIG. 4b shows, likewise in a plan view, corresponding sections of the MEA 10 adjacent to the separator plate 2 in accordance with FIG. 4A and known from the prior art or of its marginal region 15 in accordance with FIG. 2, with the marginal region 15 also being called a frame 15 in the following. Only for reasons of clarity, only some of the elements of the separator plate 2 previously described with reference to FIG. 2 are marked by reference numerals in FIG. 4A. In FIGS. 4A and 4B, the separator plate 2 and the frame 15 are deliberately shown substantially to scale to illustrate in this manner which regions of the separator plate 2 and of the adjacent MEA 10 in a plate stack of the kind of the stack shown in FIG. 1 come into alignment with one another.

The marginal section or frame 15 of the MEA 10 comprises pairs of cutouts 22a-c and a central cutout 23. The region of the membrane 14 encompassed by the marginal section 15 that comes into alignment with the active region 18 of the adjacent separator plate 2 in the plate stack of the system 1 so that protons can pass through the membrane 14 in the active region 18 of the separator plate 2 is arranged in the region of the central cutout 23 of the marginal section 15. The cutouts 22a-c of the marginal section 15 of the MEA 10 are dimensioned and the MEA 10 is arranged or arrangeable relative to the adjacent separator plates 2 such that the cutouts 22a-c align with the passage openings 11a-c of the adjacent separators plates 2 so that medium can pass through the cutouts 22a-c of the marginal section 15. In FIGS. 4A, 4B, the marginal section 15 of the MEA 10 known from the prior art is dimensioned and the MEA 10 is arranged or arrangeable relative to the adjacent separator plates 2 such that the marginal section 15 fully or at least partially covers the distribution or collection region 20 of the adjacent separator plates 2.

FIGS. 5A and FB show a section through a section of a plate stack of an electrochemical system having separator plates 2 in accordance with FIG. 4A and having MEAs 10 arranged between the separator plates 2 and known from the prior art or, in the shown section, their frame 15 in accordance with FIG. 4b, with the sectional plane in FIGS. 5A, 5B respectively being arranged perpendicular to the plate planes of the separator plates 2. In FIGS. 4A, 4B, the sectional planes of FIGS. 5A, 5B are each emphasized by an intersection line B-B that extends in the distribution and collection region 20 of the separator plate 2.

FIG. 5A shows how the marginal section 15 of the MEA 10 known from the prior art should be arranged or aligned in the ideal case in the region between the distribution and collection regions 20 of the adjacent separator plates 2. Ideally, the known MEA 10 is also encompassed or fixed between the adjacent separator plates 2 in operation such that the marginal section 15 of the MEA 10 is also clamped in the distribution or collection region 20 and is aligned in parallel with the plate planes of the separator plates 2 so that the marginal section 15 of the MEA 10 in particular does not impair the media flow through the conducting structures of the distribution or collection region 20.

In reality, however, the behavior of the marginal section 15 of known MEAs of the kind of MEA 10 actually frequently differs in operation from the ideal behavior shown in FIG. 5A since the marginal section 15 does not have sufficient structural stiffness. The unwanted behavior of known MEAs 24 frequently occurring in operation is shown in FIG. 5B. It can be seen from the representation of FIG. 5B that the marginal section 15 of the known MEA 10, amplified by the influence of the humidity, temperature, and pressure present in the operation of the electrochemical system, can at least regionally contact e.g. the distribution or collection region 20 of an adjacent separator plate 2, can penetrate into the media conducting structures of the distribution or collection region 20, and can at times greatly inhibit the media flow through the conducting structures of the distribution or collection region 20 in this manner. This can substantially reduce the efficiency of the system and may permanently deform the marginal section 15 of the MEA, which further impairs the operation of the system.

The subject matter of the present disclosure in particular relates to an improved embodiment of the marginal section 15 of known MEAs of the kind of MEA 10. The difficulties indicated in connection with FIG. 5B are remedied or reduced by the improved embodiment of the marginal section 15 proposed here. The solution proposed here comprises the marginal section 15 having at least one elevated portion and/or at least one recessed portion that serves to at least regionally increase the stiffness of the marginal section 15. The unwanted deformation of the marginal section 15 occurring in operation with known MEAs and described in FIG. 5B can be suppressed or at least substantially reduced in this manner. The efficiency of the electrochemical system in which such an improved MEA is used is thus increased. The service life of the MEA can additionally be extended.

FIG. 6a shows a separator plate 2 in accordance with FIG. 2 in a plan view, in particular of a first single plate 2a of the separator plate 2 in accordance with FIG. 2. FIG. 6B shows, likewise in a plan view, an MEA 60 of the improved kind proposed here in accordance with a first embodiment that is adjacent the separator plate 2 in accordance with FIG. 6A. And FIG. 6C schematically shows a section through the system 1 of FIG. 1 in which the separator plates 2 in accordance with FIG. 6A and the MEAs 60 are stacked alternately along the stack direction 7. The section shown only shows the marginal section 15 of the respective MEA 60. The sectional plane of FIG. 6C is oriented perpendicular to the plate planes of the separator plates 2. In FIGS. 6A, 6B, the sectional plane of FIG. 6C is respectively emphasized by an intersection line C-C.

FIG. 6B in particular shows the marginal section 15 and the region of the membrane 14 of the MEA 60 encompassed by the marginal section 15. As before, only for reasons of clarity in FIG. 6A, only some of the elements of the separator plate or bipolar plate 2 described with respect to FIG. 2 are marked by reference numerals. In FIGS. 6A and 6B, the separator plate 2 and the improved MEA 60 proposed here are in turn deliberately shown substantially to scale to illustrate in this manner which regions of the separator plate 2 and of the adjacent MEA 60 come into alignment in the plate stack of the electrochemical system 1 in accordance with FIG. 1.

As with the known MEA 10 in accordance with FIG. 4B, the marginal section 15 of the improved MEA 60 in accordance with FIG. 6B has pairs of cutouts 22a-c and a central cutout 23. In the region of the central cutout 23 of the marginal section 15 of the MEA 60, the region of the membrane 14 encompassed by the marginal section 15 is arranged that comes into alignment with the active region 18 of the adjacent separator plate 2 in the plate stack of the system 1. And, as with the MEA 10 in accordance with FIG. 4B, in the improved MEA 60, the cutouts 22a-c of the marginal section 15 of the MEA 60 are dimensioned and the MEA 60 is arranged or arrangeable relative to the adjacent separator plates 2 such that the cutouts 22a-c align with the passage openings 11a-c of the adjacent separators plates 2 so that medium can pass through the cutouts 22a-c of the marginal section 15.

In the embodiment shown in FIGS. 6A to 6C, the marginal section 15 is dimensioned and the MEA 60 is arranged or arrangeable relative to the adjacent separator plates 2 such that the marginal section 15 is received and pressed or is receivable and pressable completely or at least sectionally between the perimeter beads 12d of the adjacent separator plates 2. In addition, the circular cutouts 22b, 22c of the marginal section 15 each have a radius that is a good deal smaller than the radius of the likewise circularly extending sealing beads 12b, 12c that run around the passage openings 11b, 11c. The cut-outs 22b, 22c of the marginal section 15 are dimensioned and the MEA 60 is arranged or arrangeable relative to the adjacent separator plates 2 such that a region of the marginal section 15 encompassing the cutouts 22b, 22c is received and pressed or is receivable and pressable at least sectionally between the sealing beads 12b, 12c of the adjacent separator plates 2. In addition, FIGS. 6A, 6B show that the marginal section 15 of the MEA 60 is dimensioned and the MEA 60 is arranged or arrangeable relative to the adjacent separator plates 2 such that the marginal section 15 fully or at least partially covers the distribution or collection region 20 of the adjacent separator plates 2.

The marginal section 15 of the MEA 60 in the embodiment shown in FIGS. 6B-C respectively comprises exactly one layer of a film material that is connected to the membrane 14, e.g. by an adhesive bond or by a weld connection. The film from which the marginal section 15 of the MEA 60 is formed can e.g. be produced from a thermoplastic material or from a thermosetting material. The film material of the marginal section 15 of the MEA 60 is preferably gas-tight, of low shrinkage, chemically inert, electrically non-conductive, and temperature resistant, in particular at least in a temperature range from −50° C. to +150° C. A thickness of the marginal section 15 determined along the stack direction or z direction 7 can e.g. amount to between 35 μm and 200 μm.

The embodiment of the improved MEA 60 proposed here in accordance with FIGS. 6B-C differs from the MEA 10 in accordance with FIG. 4B known from the prior art in that the marginal section 15 of the MEA 60 has a plurality of deformations in the form of elevated portions 25a, 25b to increase the stiffness of the marginal section 15. Only for reasons of clarity, only some of the elevated portions 25a, 25b are provided with reference numerals in FIG. 6B. In the embodiment in accordance with FIGS. 6B-C, the deformations or elevated portions 25a, 25b of the marginal section 15 in the plan view in accordance with FIG. 6b respectively have a round shape and are formed in the manner of nubs. The elevated portions 25a, 25b in accordance with FIGS. 6B-C are formed in one piece with the marginal section 15 and are shaped, e.g. stamped, in the film material of the marginal section 15, for example.

It can be seen from FIG. 6B that the elevated portions and recessed portions 25a, 25b are e.g. formed in that region of the marginal section 15 of the MEA 60 that comes into alignment with the distribution or collection region 20 of the adjacent separator plate 2 in the stack of the system 1 in accordance with FIG. 1. The elevated portions and recessed portions 25a, 25b thus cover the media conducting structures of the distribution or collection region 20 at least regionally and/or they reach at least regionally to the media conducting structures of the distribution or collection region 20 of the adjacent separator plate 2. In the separator plate 2 in accordance with FIG. 6A, the media conducting structures of the distribution or collection region e.g. comprise webs and channels that establish fluid communication between the passage openings 11b and the electrochemically active region 18 of the separator plate 2. A maximum cross-section of the elevated portions and recessed portions 25a, 25b in parallel with the plane defined by the membrane 14 and in parallel with the plate planes of the separator plates 2, that is in parallel with the x-y plane, can e.g. respectively amount to at least one times or two times a maximum width likewise determined in parallel with plate planes of the separator plates 2, in particular a width determined perpendicular to the flow direction, of the media conducting structures of the distribution or collection region 20 of the separator plate 2 adjacent to the MEA 60. The maximum cross-section determined in parallel with the x-y plane, that is the cross-section at the base of the elevated portions or recessed portions 25a, 25b, can amount in each case at least to 0.5 mm, at least 1 mm, or at least 2 mm in FIGS. 6B-C. The example of the recessed portion 25b shown at the right shows that the elevated portions and recessed portions 25a, 25b do not only have to come into contact, as would be the case with support elements, but also develop their action as stiffening elements without contact.

In the embodiment in accordance with FIGS. 6B-C, a maximum height of the elevated portions or recessed portions 25a, 25b of the marginal section 15 determined along the stack direction and thus perpendicular to the plane defined by the membrane 14 can e.g. in each case amount to at least one time, two times or at least three times the maximum thickness of the film layer from which the single-layer marginal section 15 of the MEA 60 is formed. FIG. 6C shows that the elevated portions and recessed portions 25a, 25b of the marginal section 15 comprise elevated portions 25a and recessed portions 25b that each increase the total thickness of the marginal section 15. The elevated portions 25a face in the positive z direction 7 (that is upward in FIG. 6C); the recessed portions 15b are considered from the non-deflected regions of the marginal region as recessed portions; however, they could also be considered as a second kind of elevated portions that face in the negative z direction 7 (that is downward in FIG. 6C). The marginal section 15 of the MEA 60 is thus deformed by the elevated portions 25a and recessed portions 25b in both directions perpendicular to the plane defied by the membrane 14 of the MEA 60 and its thickness is increased; however, the local material thickness remains constant or is even slightly reduced due to the deformation. Under normal installation conditions and in normal operation, the elevated portions 25a and/or recessed portions 25b remain stable in shape. With somewhat increased mechanical pressure effects, the elevated portions 25a and/or recessed portions 25b can take up the acting forces via an elastic deformation. If an unusually high pressing occurs, such as on a rear-end collision, the elevated portions 25a and recessed portions 25b are plastically pressed, at times permanently, without an unwanted plastic deformation of the adjacent distributor channels in the separator plate occurring.

It can be seen from FIG. 6B that the nub-like elevated portions and recessed portions 25a, 25b are at least regionally arranged in a regular grid. The smallest spacing of adjacent elevated portions or recessed portions 25a, 25b of the marginal section 15 can amount e.g. in each case to at least one time, two times, or at least three times the maximum cross-section of the elevated portions or recessed portions 25a, 25b in parallel with the x-y plane. The elevated portions 25a and the recessed portions 25b can be respectively alternately arranged at least along a grid direction. In FIG. 6B, the elevated portions 25a and the recessed portions 25b are alternately arranged along a first grid direction and along a second grid direction, with the first grid direction and the second grid direction standing perpendicular on one another.

In the embodiment of the MEA 60 in accordance with FIGS. 6B-C, the elevated portions and recessed portions 25a, 25b of the marginal section 15 reach at least regionally up to close to the cutouts 22a-c of the marginal section 15. For example, a maximum spacing of the elevated portions and recessed portions 25a, 25b from the respective closest of the cutouts 22a-c of the marginal section 15 can respectively amount to at most five times or at most eight times the maximum cross-section of the elevated portions and recessed portions 25a, 25b in parallel with the x-y plane. The elevated portions and recessed portions 25a, 25b in the embodiment of the MEA 60 in accordance with FIGS. 6B-C are also at least partially arranged between the cutouts 22a-c of the marginal section 15 of the MEA 60 or between the passage openings 11a-c of the adjacent separator plates 2.

The elevated portions 25a and recessed portions 25b of the marginal section 15 of the MEA 60 effect a stiffening of this marginal section 15. It is thus achieved that on the positioning of the positioning aids 51 of the MEA 60 at positioning devices for stacking the MEAs 60 and separator plates 2, no warping of the marginal section 15 occurs and the MEA 60 can be installed very precisely in a correct location relative to the separator plates 60.

In a modification of the marginal section 15 of the MEA 60 in accordance with FIGS. 6B-C, that is not explicitly shown here, the marginal section 15 can also be at least regionally shaped in the manner of a corrugated metal sheet. In this case, the elevated portions and recessed portions of the marginal section 15 can then be provided by wave peaks and wave valleys of the corrugated metal sheet-like marginal section 15.

FIGS. 7A-B show the improved MEA proposed here in accordance with a further embodiment, here marked by 70. The MEA 70 can in turn be combined with separator plates or bipolar plates 2 similar to the kind shown in FIG. 6A or to the kind shown in FIG. 2. Analog to the illustration of FIG. 6B, FIG. 7A shows the MEA 70 in a plan view. And analog to the illustration of FIG. 6C, FIG. 7B schematically shows a section through the system 1 of FIG. 1 in which the separator plates 2 in accordance with FIG. 6A or in accordance with FIG. 2 and the MEAs 70 in accordance with FIG. 7A are stacked alternately along the stack direction 7. The sectional plane of FIG. 7B is oriented perpendicular to the plate planes of the separator plates 2. In FIG. 7A, the sectional plane of FIG. 7B is emphasized by an intersection line D-D that extends, like the intersection line C-C in FIG. 6B, along the distribution or collection region 20 of the adjacent separator plates 2.

Similar to the MEA 60 shown in FIGS. 6B-C, the marginal section 15 of the MEA 70 in accordance with the embodiment shown in FIGS. 7A-B has a plurality of recessed portions 25b. The recessed portions 25b of the marginal section 15 of the MEA 70 are in turn formed in nub-like manner, are shaped into the only film layer of the marginal section 15, and are inter alia arranged such that they cover the distribution or collection region 20 of the adjacent separator plate 2 at least regionally.

The MEA 70 in accordance with FIGS. 7A-B differs from the MEA 60 in accordance with FIGS. 6B-C in that the MEA 70 only has such recessed portions 25b. The recessed portions 25b of the MEA 70 are furthermore arranged at least regionally denser than in the marginal section 15 of the MEA 60. For example, the smallest spacing of adjacent recessed portions 25b of the marginal section 15 of the MEA 70 in parallel with the x-y plane can in each case amount to at most five times or at most three times the maximum cross-section of the recessed portions 25b.

The recessed portions 25b of the MEA 70 further differ from the elevated portions and recessed portions 25a, 25b of the MEA 60 in that they are completely arranged around the cutouts 22b, 22c, in particular in each case also on a side of the cutouts 22b, 22d remote from the cutout 23; they thus reach into the direct neighborhood of the positioning aids 51 and thus improve a precise and reproducible positioning of the MEA relative to the adjacent separator plates.

The recesses 25b of the marginal section 15 of the MEA 70 can be at least partially arranged in a region between the sealing beads 12b and 12d of the adjacent separator plate 2, e.g. in particular also where a spacing between the sealing beads 12b and 12d amounts to at most ten times or at most six times a minimal spacing between the sealing beads 12b and 12d. A comparison of FIGS. 6A and 7a shows that the recessed portions 25b can also in part be arranged between the sealing beads 12b and 12d of the adjacent separator plate 2 where the spacing between the sealing beads 12b and 12d is at a minimum, e.g. in each case on a side of the sealing bead 12b remote from the active region 18.

The recesses 25b of the marginal section 15 of the MEA 70 can correspondingly be at least partially arranged in a region between the sealing beads 12c and 12d of the adjacent separator plate 2, e.g. in particular also where a spacing between the sealing beads 12c and 12d amounts to at most ten times or at most six times a minimal spacing between the sealing beads 12b and 12d. A comparison of FIGS. 6A and 7a shows that the recessed portions 25b can also in part be arranged between the sealing beads 12c and 12d of the adjacent separator plate 2 where the spacing between the sealing beads 12c and 12d is at a minimum, e.g. in each case on a side of the sealing bead 12c remote from the active region 18.

FIGS. 8A-B show the improved MEA proposed here in accordance with a further embodiment, here marked by 80. The MEA 80 can in turn be combined with separator plates or bipolar plates 2 of the kind shown in FIG. 6A or of the kind shown in FIG. 2; the distribution or collection region 20 thus includes a plurality of distributor channels 29 that are arranged in parallel with one another or in a slightly fan-shaped manner and that each have a direction of extent in the plane of the bipolar plate, i.e. in parallel with the plane spanned by the inner margin or outer margin of the MEA. Analog to the illustration of FIGS. 6B and 7A, FIGS. 8A shows the MEA 80 in a plan view. And analog to the illustration of FIGS. 6C and 7B, FIG. 8B schematically shows a section through the system 1 of FIG. 1 in which the separator plates 2 in accordance with FIG. 6A or in accordance with FIG. 2 and the MEAs 80 in accordance with FIG. 8A are stacked alternately along the stack direction 7. The sectional plane of FIG. 8B is oriented perpendicular to the plate planes of the separator plates 2. In FIG. 8A, the sectional plane of FIG. 8B is emphasized by an intersection line E-E that extends, like the intersection line C-C in FIG. 6B and like the intersection line D-D in FIG. 7A, along the distribution or collection region 20 of the adjacent separator plates 2.

Unlike the previously described embodiments, the marginal section 15 of the MEA 80 in accordance with FIGS. 8A-B comprises two layers 15a, 15b of films connected to one another and to the membrane 14. The film layers 15a, 15b of the marginal section can e.g. be at least regionally adhesively bonded or welded to one another. As previously, the marginal section 15 of the MEA 80 has elevated portions 25a, 25b to increase the stiffness of the marginal section 15. The first film layer 15a in particular respectively comprises first elevated portions 25a that face in a direction remote from the second film layer 15b of the same marginal section 15 and thus in the positive z direction 7 and the second film layer 15b comprises two respective elevated portions 25a′ that face in a direction remote from the first film layer 15a of the same marginal section 15 and thus in the negative z direction 7.

In the embodiment shown in FIG. 8B, the first elevated portions 25a of the first film layer 15a and the second elevated portions 25a′ of the second film layer 15b are arranged relatively offset from one another. In a perpendicular projection in a common plane, the first elevated portions 25a and the second elevated portions 25a′ therefore do not overlap. The elevated portions 25a, 25a′ in FIG. 8B can, for example, be formed in that insert elements, not shown here, are arranged between the film layers 15a, 15b of the marginal section 15 of the MEA 80. The intermediate spaces between the film layers 15a, 15b filled or at least partially filled by such insert elements are marked by 26 in FIG. 8B. The intermediate spaces 26 can e.g. be filled with an adhesive material. The intermediate spaces 26 can equally remain unfilled, however.

Unlike the previously described MEAS 60. 70, the elevated portions 25a, 25a′ of the marginal section 15 of the MEA 80 each have an elongate shape. A length of the elevated portions 25a, 25a′ of the MEA 80 along their direction of extent can e.g. respectively amount to at least five times or at least ten times their minimal width. Alternatively or additionally, a length of the elevated portions 25a, 25a′ of the MEA 80 along their direction of extent can respectively amount to at least five times or at least ten times a minimal width, in particular a width measured perpendicular to the direction of flow, of the media conducting structures of the distribution or collection region 20 of the adjacent separator plate 2, for example at least five times or ten times a minimal channel or web width. In FIG. 8A, the elevated portions 25a, 25a′ each extend in a straight direction, here along the y direction 9. In alternative embodiments, the elevated portions 25a, 25a′ can, however, equally have a curvilinear extent at least sectionally. Transversely to their direction of extent, that is along the x direction 8 in FIG. 8A, adjacent elevated portions 25a, 25a′ of the marginal section 15 of the MEA 80 have a spacing that e.g. amounts to at most twice the minimal width of the elevated portions 25a, 25a′.

A comparison of FIGS. 6A and 8A furthermore shows that the elongate elevated portions 25a, 25a′ of the marginal section 15 of the MEA 80 in accordance with FIG. 8A extend or are aligned such that they at least sectionally intersect the channels and webs of the distribution or collection region 20 of the adjacent separator plate 2, that is in particular the distributor channels 29, and their main direction of extent with the direction of extent of the distributor channels 29 spans an angle of a little more than 30°. It can thus be particularly effectively prevented that the marginal section 15 of the MEA 80 in FIG. 8A like the marginal section 15 of the MEA 10 in FIG. 5b penetrate into the media conducting structures of the distribution or collection region 20 of the adjacent separator plate 2 or reaches into it and thus blocks it completely or partially.

FIG. 9 shows a plan view of an MEA 90 in accordance with a further embodiment that is a variant of the MEA 80 in accordance with the embodiment shown in FIGS. 8A-B. The MEA 90 can in turn be combined with separator plates or bipolar plates 2 similar to the kind shown in FIG. 6A or to the kind shown in FIG. 2. The elevated portions 25a of the marginal section 15 of the MEA 90 in accordance with FIG. 9 differ from those of the marginal section 15 of the MEA 80 in accordance with FIG. 8A in that the elevated portions 25a of the MEA 90 each have a reduced length with respect to those of the MEA 80 along its extent following the y direction 9. The spacing of adjacent elevated portions 25a along the x direction 8 in FIG. 9 is additionally larger than in FIG. 8A. The spacing of adjacent elevated portions 25a of the marginal section 15 of the MEA 90 in the x direction 8 can e.g. respectively have at least twice or at least three times their minimal width likewise determined along the x direction 8. The different elevated portions 25a of the marginal section 15 of the MEA 90 in accordance with FIG. 9 are arranged in rows and columns, with the rows extending in the x direction 8 and the columns extending in the y direction 9. The main direction of extent of the elevated portions here extends in the y direction and thus in turn at an angle of 30° to the direction of extent of the distributor channels 29 in FIG. 6A.

FIG. 10 shows a plan view of an MEA 100 in accordance with a further embodiment that is a variant of the MEA 60 shown in FIGS. 6B-C. The MEA 100 in accordance with FIG. 10 differs from the MEA 60 in accordance with FIGS. 6B-C in a modified geometry of the periphery of the marginal section 15 and in a modified geometry and arrangement of the cutouts 22a-c and of the elevated portions 25a, 25b. FIG. 10 shows a different design of the positioning aid 51 of the marginal region 15. The positioning aid 51 here, as in the preceding examples, has a notch or a recess with respect to the adjacent outer margin of the plate. A cutout 53 is additionally provided that enables a targeted evasion of the web 54. However, the movability of the total region 55 is reduced by the elevated portions and recessed portions 25a, 25b so that an evasion of the film material of the marginal region 15 from the x-y plane is also prevented here and the MEA 100 is positioned by the contact at the positioning device, not shown here, precisely and in the correct location between the separator plates 2.

FIG. 11A shows a plan view of an MEA 110 in accordance with a further embodiment. The elevated portions 25c of the marginal section 15 of the MEA 110 have an elongate shape in part and a nub-like shape in part. The MEA 110 can in turn be combined with separator plates or bipolar plates 2 of the kind shown in FIG. 6A or of the kind shown in FIG. 2. In FIG. 11A, the extent and the arrangement of the elevated portions 25c of the marginal section 15 to the right of the membrane 14 correspond approximately e.g. to the extent and the arrangement of the elevated portions 25a, 25b in accordance with FIG. 8A. And in FIG. 11A, the arrangement of the elevated portions 25a of the marginal section 15 to the left of the membrane 14 corresponds at least in part to the arrangement of the elevated portions 25a, 25b in accordance with FIG. 7A. The marginal section 15 of the MEA 110 in accordance with FIG. 11a furthermore also has further elevated portions 25a in regions 27 of the marginal section 15 that are arranged transversely or substantially transversely to connection lines between the pairs of cutouts 22a-c at both sides of the membrane 14 in fluid communication with one another. These further elevated portions 25a in the regions 27 of the marginal section 15 are arranged in the plate stack of the system 1 in accordance with FIG. 1 between the perimeter bead 12d and the electrochemically active region 18 of the adjacent separator plate 2. It is possible by this arrangement to form the support structure formed in the corresponding region of the adjacent separator plate 2 with a substantially lower height and thus to achieve an improved seal. The elevated portions 25a can here prevent or reduce an unwanted fluid flow through this intermediate space and past the electrochemically active region 18 of the adjacent separator plate 2.

FIG. 11B schematically shows a section through the system 1 of FIG. 1 in which the separator plates 2 are substantially alternately stacked along the stack direction 7 in accordance with FIG. 6A or in accordance with FIG. 2 with MEAs e.g. of the kind of the MEA 110 in accordance with FIG. 11a. The sectional plane of FIG. 11B is here oriented perpendicular to the plate planes of the separator plates 2. Like the sections shown in FIGS. 6C, 7B, 8B, the section of FIG. 11b can also extend in FIG. 11A along one of the distribution or collection regions 20 of the separator plates 2, here in particular along the line F-F in the distribution or collection region 20 to the left of the membrane 14 having nub-like elevated portions 25c.

In FIG. 11b, the marginal sections 15 of the MEAs 110 each comprise at least two film layers 15a, 15b and an adhesive layer 28 that is arranged between the film layers 15a, 15b and that connects the film layers 15a, 15b of the marginal section 15 to one another. The first elevated portions 25a facing in the positive z direction 7 and the second elevated portions 25b facing in the negative z direction are here formed by a variation of a thickness of the adhesive layer 28 in the x-y plane, with the thickness of the adhesive layer 28 being determined along the stack direction or along the z direction 7; overall, they form elevated portions or thickened portions 25c that face in both z directions.

Unlike in the marginal section 15 of the MEA 80 in accordance with FIG. 8b, the elevated portions 25a, 25b of the marginal section 15 of the MEA 110 in accordance with FIG. 11B are arranged such that their orthogonal projections in a plane in parallel with the plate planes of the separator plates 2 overlap in full or at least in part.

In FIG. 11B, a maximum thickness of the marginal section 15 is e.g. at least twice as large or at least three times as large as a minimal thickness of the marginal section 15. The maximum thickness of the marginal section 15 here occurs in the region of the elevated portions 25a, 25b overlapping one another along the stack direction and the minimal thickness of the marginal section 15 here occurs in the region between the elevated portions 25a, 25b. The marginal section 15 of the MEA 110 in accordance with FIG. 11B having two film layers 15a, 15b and having an adhesive layer 28 arranged between the film layers 15a, 15b can e.g. be manufactured in a mold by pressing or by laminating the adhesive layer 28 between the film layers 15a, 15b, in particular under the effect of heat. The elevated portions 25a, 25b shown in section in FIG. 11B can be formed e.g. in nub shape in the plan view like the nub-like elevated portions 25a, 25b to the left of the membrane 14 or in the regions 27 in FIG. 11A. If instead of the section F-F of FIG. 11A, a section to the left of the membrane 14 were looked at, the elevated portions 25a, 25b shown in section in FIG. 11B would be formed as elongate.

It is alternatively conceivable that the marginal sections 15 shown in FIG. 11b are not formed, as previously explained, from two film layers 15a, 15b and an adhesive layer arranged between the film layers 15a, 15b, but from a single film layer having a variable thickness. Such a single-layer marginal section having elevated portions of the kind of the elevated portions 25a, 25b shown in FIG. 11B can e.g. be shaped from a thermoplastic film by shaping or pressing in a mold. In this respect, the region of the marginal region 15 that overlaps in the MEA with the membrane 14 is also tapered with respect to the original thickness of the film material.

FIG. 12 schematically shows a section through the system 1 of FIG. 1 in which the separator plates 2 in accordance with FIG. 6A or in accordance with FIG. 2A having MEAs 120 are stacked alternately along the stack direction 7 in accordance with a further embodiment. The sectional plane of FIG. 12 is here oriented perpendicular to the plate planes of the separator plates 2. Like the sections shown in FIGS. 6C, 7B, 8B, the section of FIG. 12 can also e.g. extend along one of the distribution or collection regions 20 of the separator plates 2.

The marginal section 15 of the MEA 120 in accordance with FIG. 12 comprises a film layer 15a. The elevated portions 25a′ facing in the negative z direction 7 are provided in FIG. 12 by reinforcement elements that are joined with the film layer 15a. The reinforcement elements forming the elevated portions 25a′ can e.g. be formed from the same film material as the film layer 15a. In other words, the marginal section 15 in the MEA 120 in accordance with FIG. 12 is thus only formed with double layers in the reinforced regions and thus only regionally. A maximum thickness of the marginal section 15 in the region of the elevated portions 25a′ can, for example, be at least twice a minimal thickness of the marginal section 15 between the elevated portions 25a′. It is, however, equally conceivable that the reinforcement elements forming the elevated portions 25a′ are formed from a material that differs from the material of the film layer 15a. The reinforcement layers that form the elevated portions 25a′ of the marginal section 15 of the MEA 120 in accordance with FIG. 12 can e.g. be adhesively bonded and/or laminated onto the film layer 15a. In the plan view, i.e. in the x-y plane, the reinforcement elements of the marginal section 15 of the MEA 120 in accordance with FIG. 12 forming the elevated portions 25a′ can e.g. in turn be formed as nub-like and/or as elongated, e.g. corresponding to the elevated portions 25a′ of the marginal section 15 of the MEA 110 in accordance with FIG. 11A. They can, however, also consist of an at least partially contiguous grid.

FIGS. 13A-B shows a plan view of an MEA 130 in accordance with a further embodiment. FIG. 13A here shows the MEA 130 during its manufacture, and FIG. 13B shows the finished MEA 130. The finished MEA 130 can in turn be combined with separator plates or bipolar plates 2 of the kind shown in FIG. 6A or of the kind shown in FIG. 2. The finished MEA 130 in accordance with FIG. 13B is characterized in that a film layer of the marginal section 15 is folded over and doubled in each case along a fold edge 30 at two oppositely disposed ends to the left and right of the membrane 14 for an at least regional doubling of this film layer. The marginal section 15 of the finished MEA 130 in accordance with FIG. 13B thus comprises at least regionally at least two film layers 15a, 15b that are formed in one piece and that are connected to one another along the fold edges 30. The fold edges 30 are here each arranged at an end of the region of the marginal section 15 comprising the at least two film layers 15a, 15b facing the membrane 14 or the active region 18 of an adjacent separator plate 2. FIG. 13A shows how the film layer 15a for forming this at least regional doubling along sectional lines 31 can e.g. be cut out or stamped out of the film of the marginal section 15 comprising the film layers 15a, 15b.

The film layer 15a manufactured by the folding over and doubling and facing the observer of FIG. 13B thus forms an at least regional reinforcement or elevated portion 25a of the marginal section 15 of the MEA 130. The folded over film layer 15a forming the elevated portion 25a in the doubled and reinforced region of the marginal section 15 of the MEA 130 can e.g. be adhesively bonded or otherwise connected with material continuity to the non-folded film layer 15b. The two doubled film layers 15a, 15b of the marginal section 15 can e.g. in turn be arranged in the distribution or collection region 20 of an adjacent separator plate 2 of the system 1 in accordance with FIG. 1. A stiffening of the marginal section 15 of the MEA 130 in accordance with FIG. 13B effected by the regional doubling can in turn counteract the unwanted deformation and the unwanted penetration shown in FIG. 5B of the marginal section 15 into the media conducting structures of the distribution or collection region 20 of an adjacent separator plate 2.

FIG. 14 shows a sectional view of a section of an electrochemical system in which, unlike in most preceding sectional illustrations, the margin of the membrane 14 is also shown. Here, the margin of the membrane 14 on both surfaces is adjacent to one of the two film layers 15a, 15b. The two film layers 15a, 15b are spaced apart from one another in the region adjacent to the margin of the membrane 14, but lie directly on one another in the remaining marginal region 15 and are areally adhesively bonded to one another. They are shaped together to form a reinforcement of the marginal region such that they form elevated portions 25a and recessed portions 25b. The two film layers 15a, 15b form a structure like a corrugated metal sheet overall.

1. An electrochemical system comprising:
a first separator plate and a second separator plate, and
a membrane electrode assembly (MEA) arranged between the separator plates, wherein the MEA has a membrane for forming an electrochemical cell and a marginal section connected to the membrane and comprising a film material for positioning and/or for fastening the membrane between the separator plates wherein the marginal section has at least one elevated portion and/or recessed portion for an at least regional stiffening of the marginal section.

2. The electrochemical system according to claim 1, wherein electrochemically active region arranged between the first and second separator plates, with at least one of the separator plates having a passage opening and at least one distributor channel that establishes fluid communication between the passage opening and the electrochemically active region, with the at least one elevated portion and/or the at least one recessed portion of the marginal section of the MEA covering the at least one distributor channel at least sectionally, and/or with the at least one elevated portion and/or the at least one recessed portion of the marginal section of the MEA being adjacent to the at least one distributor channel.

3. The electrochemical system according to claim 1, further comprising an electrochemically active region and a first sealing arrangement for sealing the electrochemically active region.
wherein the at least one elevated portion and/or the at least one recessed portion of the marginal section of the MEA being arranged between the first sealing arrangement and the electrochemically active region and completely or at least regionally closing an intermediate space formed between the first sealing arrangement and the electrochemically active region so that it prevents or reduces an unwanted fluid flow through the intermediate space and past the electrochemically active region.

4. The electrochemical system according to claim 1, further comprising an electrochemically active region,
at least one passage opening in the first and/or second separator plates,
a first sealing arrangement for sealing the electrochemically active region, and
a second sealing arrangement for sealing the at least one passage opening,
wherein the at least one elevated portion and/or the at least one recessed portion of the marginal section of the MEA being arranged in a region between the first sealing arrangement and the second sealing arrangement, in which region a spacing of the first sealing arrangement from the second sealing arrangement amounts at most to ten times a minimal spacing between the first sealing arrangement and the second sealing arrangement.

5. (canceled)

6. The electrochemical system according to claim 1, wherein the at least one elevated portion and/or recessed portion is/are formed in one part with the marginal section.

7. The electrochemical system according to claim 1, wherein the marginal section of the MEA is formed at least regionally in the manner of a corrugated metal sheet, with the elevated portions and/or the recessed portions being provided by wave valleys and wave peaks of the corrugated metal sheet-like region.

8. The electrochemical system according to claim 1, wherein the at least one elevated portion and/or the at least one recessed portion is/are shaped in the marginal section of the MEA.

9. The electrochemical system according to claim 1, wherein the at least one elevated portion comprises at least one first elevated portion elevated toward the first separator plate and/or at least one second elevated portion elevated toward the second separator plate.

10. The electrochemical system according to claim 1, wherein the at least one elevated portion and/or the at least one recessed portion has/have an elongate shape.

11. The electrochemical system according to claim 1, wherein the at least one elevated portion and/or the at least one recessed portion is/are formed in a nub-like manner.

12. The electrochemical system according to claim 1, wherein the at least one elevated portion and/or the at least one recessed portion has a main direction of extent in a plane in parallel with the plate plane; and in that the at least one distributor channel of the separator plate adjacent to the marginal section has a direction of extent that includes an angle of at least 20°, with the main direction of extent of the elevated portion or the recessed portion.

13. The electrochemical system according to claim 1, wherein at least one reinforcement element is arranged at least regionally on the marginal section and is joined to the marginal section to form the at least one elevated portion.

14. (canceled)

15. The electrochemical system according to claim 1, wherein the at least one elevated portion and/or the at least one recessed portion is/are implemented by a variation of a thickness of the film material of the marginal section of the MEA.

16. The electrochemical system according to claim 1, wherein the marginal section of the MEA at least regionally comprises two film layers connected to one another.

17. The electrochemical system according to claim 16, wherein the marginal section of the MEA comprises a film layer having a section folded over for the doubling of said film layer to form the region of the marginal section comprising at least two film layers.

18. The electrochemical system according to claim 17, further comprising an electrochemically active region, with a fold edge of the folded film section being arranged at an end of the region of the marginal section of the MEA comprising at least two film layers facing the electrochemically active region;
a first film layer facing the first separator plate comprising at least one first elevated portion elevated toward the first separator plate; and
a second film layer facing the second separator plate comprising at least one second elevated portion elevated toward the second separator plate.

19. (canceled)

20. The electrochemical system according to claim 18, wherein the separator plates each define a plate plane; and
the at least one first elevated portion and the at least one second elevated portion are arranged at least partially overlapping in an orthogonal projection in the plate planes of the separator plates.

21. The electrochemical system according to claim 18, wherein the separator plates each define a plate plane;
and in that the at least one first elevated portion and the at least one second elevated portion are arranged at least partially offset relative to one another in an orthogonal projection in the plate planes of the separator plates.

22. The electrochemical system according to claim 16, wherein the marginal section of the MEA comprises at least one adhesive layer arranged between the film layers; and
the at least one elevated portion and/or the at least one recessed portion is/are implemented by a variation of a thickness of the adhesive layer.

23. The electrochemical system according to claim 16, wherein the at least one elevated portion and/or the at least one recessed portion is/are implemented by a variation of a thickness of the marginal section of the MEA by insert elements arranged between the film layers.
